(19) United States
(12) Patent Application Publication
(10) Pub. No.: US 2012/0101875 A1
(43) Pub. Date: Apr. 26, 2012

(54) STORED VALUE EXCHANGE METHOD AND APPARATUS

(76) Inventors: CHRIS NICOLAIDIS, Encinitas, CA (US); Steven J. Davis, Encinitas, CA (US)

(21) Appl. No.: 12/909,818

(22) Filed: Oct. 21, 2010

(51) Int. Cl. G06Q 30/00

(52) U.S. Cl. 705/14.1

(57) ABSTRACT

An apparatus and method for exchanging one form of stored value for another form of value. In one embodiment, an apparatus comprises means for providing stored-value account information to a first remote entity and to a second remote entity. The apparatus further comprises means for receiving a first offer to exchange at least some of the stored value for another form of value from the first remote entity and for receiving a second offer to exchange at least some of the stored value for another form of value from the second remote entity. The apparatus additionally comprises means for accepting one of the offers.

### BACKGROUND

I. Field of Use

The present application relates to the field of consumer stored value methods and apparatus. More specifically, the present application relates to methods and apparatus for exchanging one form of stored value for an alternative form of value.

II. Description of the Related Art

Over the years, stored-value cards, such as gift cards, have become popular with consumers. A typical stored-value card is issued by a merchant in the shape of a credit card and contains magnetically encoded data. The data may be read by a magnetic card reader, which ascertains a value represented by the stored-value card and a merchant associated with the stored-value card.

Stored-value cards typically come in one of two forms. “Closed” stored-value cards can only be redeemed at merchants associated with the stored-value card. “Open” stored-value cards may be redeemed at a variety of merchant stores or websites.

Stored-value cards are used to pay for products and/or services, typically by presenting the stored-value card to a cashier or automated device, or by providing information found on the stored-value card to a web-site that accepts stored-value cards as payment. The merchant (or third party) determines the value of the stored-value card and determines whether there is a sufficient balance on the stored-value card to complete the purchase. If a sufficient balance exists, the transaction continues, and the monetary value encoded upon the stored-value card is reduced by the purchase amount to reflect a new balance. Alternatively, the monetary value associated with the stored-value card is reduced on a remote computer maintained by the stored-value card vendor, merchant, or other party.

The fact that most stored-value cards can be used only within a specific issuing chain of merchants can present problems to stored-value card holders. A person may have received a stored-value card that is usable at a particular merchant where the person does not desire to make a purchase. For example, a person may have received a stored-value card that is redeemable at a home improvement store, but the person does not own a home and therefore has no interest in purchasing goods or services from the home improvement store. Or, the person may have received a stored-value card that is only valid at a certain restaurant chain, but the person does not like the particular restaurant chain.

To address this problem, several websites, such as plasticjungle.com, cardpool.com, swapagift.com, and others, offer a stored-value card exchange service. Users of such sites can trade their stored-value cards for other stored-value cards redeemable at merchants from whom they would rather conduct business. Typically, a user accesses such a website, selects a merchant and a stored-value card amount that the user would like to use, and enters information relating to the user's stored-value card that he/she currently possesses. The value of the preferred stored-value card is generally less than the value of the user's currently-possessed stored-value card. Once the user selects a desired stored-value card and value, the user mails the currently possessed stored-value card to an address associated with the stored-value card exchange website, and the desired stored-value card is mailed to the user after the undesired stored-value card is received by operators or owners of the stored-value card exchange website.

One problem with the above-described scenario is that the user is forced to accept the options presented to him/her by the stored-value card exchange website. For example, if the user currently possesses a $50 stored-value card redeemable at a first merchant, but wants to trade it for a stored-value card redeemable at a second merchant, the website will present offers to the user for stored-value cards at a value less than the $50 value of the user's currently possessed stored-value card. If the user does not wish to trade the currently possessed stored-value card for the amount offered by the stored-value card exchange website, or if there is no alternative cards associated with merchants that the user would prefer to do business with, he or she must go to another website, and repeat the process of entering information about the currently possessed stored-value card, searching through alternative desired and available stored-value cards, etc.

It would be desirable if more options were available to users who wish to exchange their undesirable stored-value cards.

### SUMMARY

The embodiments described herein relate to methods and apparatus for exchanging one form of stored value for another form of value. In one embodiment, an apparatus for exchanging stored value is described, comprising a network communication interface for sending stored-value account information relating to the stored value to a first remote entity and to a second remote entity, and for receiving a first offer to exchange at least some of the stored value for an alternative form of value. A user output device is used to presenting the first and second offers to a user and a user input device is used to receive an indication from the user of an acceptance of one of the offers.

In another embodiment, a method for exchanging a stored-value card is described, comprising electronically sending stored-value account information relating to the stored value to a first remote entity and to a second remote entity and electronically receiving a first offer to exchange at least some of the stored value for another form of value from the first remote entity and receiving a second offer to exchange at least some of the stored value for another form of value from the second remote entity. One of the offers may then be accepted.

In yet another embodiment, an apparatus for exchanging a stored-value card is described, comprising means for providing stored-value account information relating to the stored value to a first remote entity and to a second remote entity and means for receiving a first offer to exchange at least some of the stored value for another form of value from the first remote entity and for receiving a second offer to exchange at least some of the stored value for another form of value from the second remote entity. The apparatus further comprises means for accepting one of the offers.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of an apparatus for exchanging a stored-value card for another form of value;

FIG. 2 is a functional block diagram illustrating the functional components of the apparatus shown in FIG. 1; and

FIG. 3 is a flow diagram illustrating an embodiment for exchanging stored-value cards.

### DETAILED DESCRIPTION

The present description relates to methods and apparatus for exchanging one form of stored value for another form of value. The term “value”, as used herein, comprises anything of monetary worth, such as money, credit, time (e.g., long-distance, payphone, or cell phone minutes), access to events, access to travel services, merchandise, social network credits (i.e., MySpace, Facebook), gasoline, and the like. The term “stored value” comprises any value that is, or can be, stored or represented in or on a physical object or device. Examples of a physical object or device comprise stored-value cards, such as gift cards, credit cards, pre-paid phone cards, payroll cards, debit cards, wireless communication devices such as mobile telephones, smart phones, mobile computing devices, such as an iPad or the like, fixed computing devices, servers, smart phones, key fobs, vouchers, or any instrument useable in commerce in place of money, or any instrument that entitles the bearer to acquire, utilize, or exhaust any commercially available product or service. “Stored-value account information” comprises an account identification, such as an account number, an account value or balance, an amount of the account value or balance willing to be exchanged for another form of value, a merchant or financial institution associated with the account value or balance, and/or an identification of the account owner. Further, as used throughout this description, the term “card” shall be understood to include both prepaid and non-prepaid cards, unless the particular context requires otherwise.

Stored-value cards typically comprise plastic cards in the size and shape of a typical credit card, and often having a readable magnetic strip, bar code, computer/memory chip, smart chip, or the like embossed on one side. The magnetic strip is sometimes encoded with stored-value account information, as defined above. In other embodiments, the strip comprises a unique identifying code which is used to access an account associated with the unique identifying number.

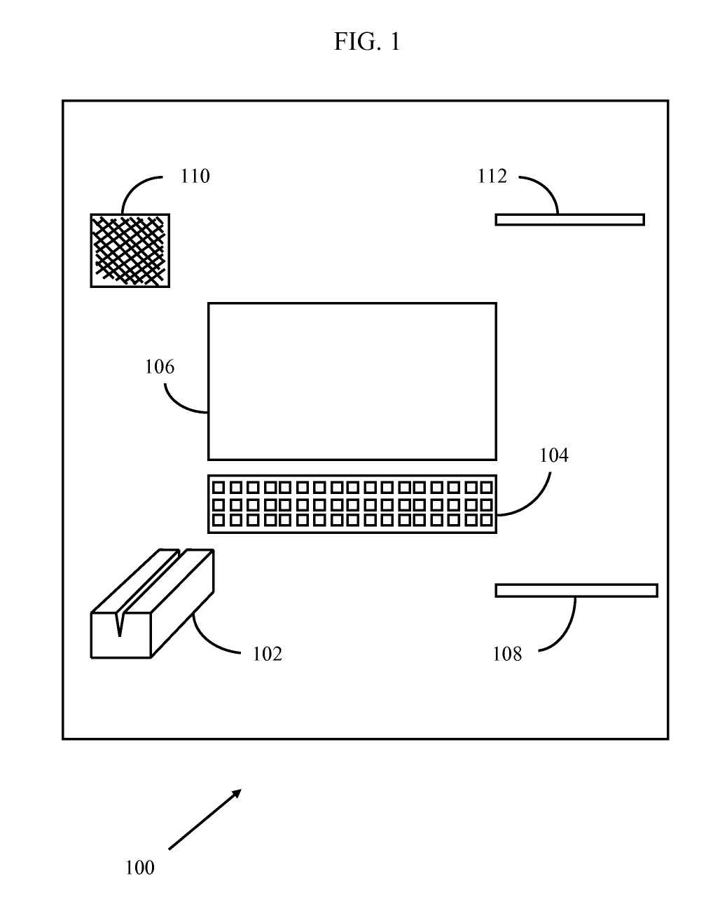

FIG. 1 illustrates an apparatus for exchanging stored value for another form of value in accordance with one embodiment of the teachings of the present disclosure. It should be understood that the “another form of value” could be the same type of physical object as the form of the stored value. In other words, the term “exchanging stored value for another form of value” can comprise exchanging a first gift card redeemable at a first merchant for a second gift card redeemable at a second merchant. It should also be understood that exchanging stored value may comprise exchanging only some, or a portion of, any given stored value.

In the embodiment shown in FIG. 1, apparatus 100 comprises a kiosk, which, in general, is a transaction machine that is typically distributed publically for use by individuals. Kiosks have enjoyed a great deal of popularity in recent years, because they allow users to quickly purchase certain items without the use of human cashiers, which can sometimes slow down the purchasing process. A variety of items are typically offered by kiosks, such as lottery tickets, movie rentals, and of course, banking transactions. Apparatus 100 allows users to exchange their stored value for other forms of value. In other embodiments, the apparatus for exchanging stored value comprises a fixed or mobile personal computer or a personal wireless device, such as a wireless telephone, smart phone, or iPad.

Apparatus 100 typically comprises one or more user input devices, such as card reader 102, a keypad or keyboard 104, a touch-screen device, an optical scanner 110, an RFID receiver and/or other means for users to enter information into apparatus 100. Apparatus 100 additionally comprises a user output device 106, such as a visual display, an audio output device (such as an audio speaker), or both. In some embodiments, the elements of user input devices and user output devices are combined, such as the case of a display device that operates as a touch-screen input device or provides a “virtual” keyboard to the user. Apparatus 100 also typically comprises a transaction output device 108, for providing a user of apparatus 100 a receipt of any transactions or providing an alternate form of value to the user. It should be understood that in other embodiments, the number, placement, and function of these features may differ from the configuration shown in FIG. 1. For example, in another embodiment, keypad 104 could be eliminated and a user touch-screen device offered in conjunction with a visual display as part of user output device 106. In yet another embodiment, card reader 102 could be eliminated and information relating to stored-value cards could be entered either through keypad 104 or the touch-screen device just described. In yet another embodiment, where apparatus 100 comprises a smart phone, the user input device(s) may comprise a keypad or keyboard (virtual or otherwise), microphone, magnetic strip reader, RFID receiver, and/or optical reader, while the user output device(s) may comprise simply a display and speaker.

In a typical transaction, a user of apparatus 100, such as an individual, desires to exchange at least some stored value owned by the user for another form of value. For example, the user might possess a gift card having a certain monetary value that was given to the user as a gift from a third party. In many cases, these gift cards may only be redeemed at a merchant associated with the gift card. For example, the gift card might be redeemable only at a particular home improvement store, such as Home Depot. The user may not have a desire to shop at the particular merchant that is associated with the gift card and, therefore, may want to exchange the gift card currently in his/her possession for another form of value, such as a gift card associated with another merchant, a pre-paid debit or credit card, cash, a pre-paid phone card, etc.

In another example, the user might possess a smart phone, having wireless voice and data capabilities. In this embodiment, user's stored value may be stored within a memory or application resident on the smart phone, or accessible via the smart phone from a remote entity, such as a server or web site.

In one embodiment, a user wishing to exchange at least some of the user's stored value for another form of value begins a stored value exchange by providing stored value account information to apparatus 100 using one or more of the user input devices, such as card reader 102, keypad or keyboard 104, a touch-screen device, an optical scanning device 110, such as a bar-code scanner, an RFID receiver, a wi-fi or bluetooth receiver, etc. In one embodiment, the stored value account information comprises an identification code. In this case, the identification code alone is enough to identify the stored-value account, an amount of the account value or balance willing to be exchanged for another form of value, one or more merchants associated with the account, an account balance, and/or an identification of an account owner. In other embodiments, the stored-value account information comprises an account number, one or more merchant(s) associated with the account, an account balance, and/or an identification of an owner of the account. The stored value information could comprise other types of information as well.

The stored-value account information may be provided to apparatus 100 by swiping a stored-value card, having the stored-value account information stored thereon, through reader 102 or providing the card to apparatus 100 via a card-capturing reader, manually entering stored value information into a keyboard, keypad, touchscreen device, or wirelessly providing the stored-value account information to apparatus 100 from an object or device having the stored-value account information stored thereon within proximity of an RFID receiver, wi-fi receiver, bluetooth receiver, optical scanner, or other wireless technology well known in the art.

In embodiments where apparatus 100 comprises a personal computing device, wireless telephone, smart phone, and the like, the stored value and/or stored-value account information, is typically provided to apparatus 100 from a remote entity of a past transaction. For example, a user could have a smart phone that comprises stored value that was sent to the smart phone from a merchant after the user paid money to receive credit redeemable at the merchant's place of business. In another embodiment, the smart phone receives stored-value account information. To redeem the stored value, the user transfers the stored value to the merchant during the check-out process by bringing the smart phone in close physical proximity to a receiver, typically located at or near the merchant's check-out stand. The receiver is configured to read the credit stored on the smart phone by electrical, RF, optical, or other means. The stored value, or stored-value account information, may be displayed as a bar code or other graphical representation on the display of the smart phone or it may be transmitted by wire or wirelessly to the merchant's receiver during check-out.

After the apparatus 100 has received the stored-value account information, the user output device 106 may instruct the user how to proceed for each step of the transaction, either visually if output device 106 is a display device, audibly if output device 106 is an audio device such as a speaker, or a combination of both. In one embodiment, the user provides an identification of a preferred merchant that the user would like to transact with in the future, with the hope that the user will be able to exchange the user's present stored value with an alternate form of value associated with the preferred merchant. This information can be sent in addition to the stored value account information to remote entities to alert them that the user would prefer alternative forms of value relating to the preferred merchant. In addition, or in the alternative, the apparatus 100 can send the stored-value account information directly to the preferred merchant (or merchant's website or web server) in hopes of receiving an offer from the preferred merchant directly.

The stored-value account information may also be validated and/or verified using a third-party service or it may be verified by merchants or businesses that specialize in stored-value card exchanges, as is well known in the art. In these embodiments, the apparatus 100 sends the stored-value account information to such third party service providers, merchants, or other entities. In one embodiment, after validation/verification by a third party service provider, the stored-value account information may be provided to at least two entities wishing to exchange the user's stored value, rather than being provided by apparatus 100.

The stored value account information, and any other information, is sent by apparatus 100 to at least two remote entities. For example, the stored-value account information may be sent to a first website or web server and also to a second website or web server, each associated with a particular merchant, or a financial institution, a stored value exchange service, and/or an individual. It can further be sent to any number of additional entities. In addition to websites and web servers, the stored-value account information can, alternatively or in addition, be sent to any number of other remote entities, such as personal desktop or mobile computers or personal mobile devices, such as smart phones, iPads, iPhones, etc. The identity and location/address of the entities may be predetermined by storing information relating to each entity inside apparatus 100, may be provided by the user via the user input device, or a combination of both, i.e., apparatus 100 providing a list of default entities and then the user selecting one or more of the provided entities and/or the user entering entity information (i.e., merchant name, web address, address, and/or telephone number) relating to the user's preferred merchants.

Each of the remote entities receives the stored-value account information and determines whether it is willing and capable of submitting an offer for at least some of the user's stored value. Typically, these entities determine a merchant (if any) associated with the stored-value account information, and an amount of value that the stored-value account information represents. Each remote entity may then choose to provide an offer to exchange the user's stored value for another form of value or it may not choose to submit an offer. For example, stored-value account information representing a Sears gift card worth $100, may be sent to three remote entities. The first remote entity, a stored value exchange service, might choose to offer a stored-value card associated with a different merchant to the user in either the same amount or, more frequently, an amount that is less than the balance on the user's stored-value card. In this example, the first entity might choose to offer a gift card or pre-paid debit card to the user worth only $90, redeemable only at, for example, Home Depot. The second entity might choose to offer a Lowes stored-value card worth $92. The third entity may offer the user a pre-paid debit card worth $76. Each entity is typically free to craft their own form of value. In other words, each entity is generally free to offer whatever form of value they choose to the user in exchange for at least some of the value associated with the user's stored value. The value may take any form, including a pre-paid debit card, a pre-paid credit card, a pre-paid phone card, movie tickets, cash, live entertainment tickets such as sporting event tickets, concert tickets, or theater tickets, travel vouchers, fuel credit, merchandise, social network credits, (i.e., MySpace or FaceBook) or anything else of value. Each of the entities sends their respective offers to apparatus 100 in hopes of having their offer accepted by the user.

The three offers are received from the three remote entities by apparatus 100 over a communication link, typically a wide area network, telephone, fiber optic, satellite, or wireless network. In one embodiment, the three offers are provided to the user via user output device 106. The user selects one of the three offers for exchanging the user's currently possessed stored value by entering an indication of acceptance using user input device 104. If the user does not wish to accept any of the offers, the user may cancel the transaction by entering an indication of refusal into user input device 104. The indication, in any case, may be made using keypad 104, a touch-screen device, or by audible means.

In some cases, an entity might offer more alternative value than what the user's stored value is worth. For example, a financial institution, such as a debit-card provider, might offer $55 for a user's stored value worth only $50. The financial institution might offer more value to a user in order to get the user to at least try the financial institution's products and services, such as reloadable debit cards. The concept of offering more alternative value than the user's stored value could be used by most commercial entities, such as merchants (i.e., restaurants, retail stores, etc). If such an offer is accepted by a user, the financial institution typically sells or exchanges the user's stored to recoup as much value as possible.

In another embodiment, the user does not make the decision of which offer to accept. Rather, a processor located within apparatus 100 selects one of the offers automatically, based on a set of predetermined criteria that is either provided by the user or stored in a memory, either inside apparatus 100 or available to the processor at a remote location, accessible through the communication link. In this embodiment, the user will typically have the final decision of whether to accept the processor's selection.

If one of the offers is accepted, either by the user, automatically, or by a combination of both, an indication of the acceptance is received from the user via user input device 104 and a notification of the acceptance is provided at least to the entity that submitted the chosen offer. A second notification may also be sent to the second, third, and any other entity that submitted an offer that was not accepted. The second notification may comprise information relating to the entity who placed the accepted offer and/or the value that was accepted for exchange from the selected entity. If no offers were accepted, a notification of such could also be sent to all remote entities that provided offers, possibly also including information relating to the value that was offered from all of the entities that provided an offer.

In one embodiment, if one of the offers was accepted, an alternative form of value offered by the remote entity associated with the selected offer may be given to the user during the user's current session with apparatus 100. For example, if the alternative form of value chosen is a stored-value card, event tickets, cash, social network credits (i.e., MySpace or FaceBook), or some other form of tangible stored value able to be dispensed by apparatus 100, that form of value may be provided to the user via transaction output device 108. Transaction output device 108 typically comprises a printer for printing receipts, a magnetic strip encoding mechanism, a cash dispensing mechanism, a ticket dispensing mechanism, or the like, for dispensing a form of value to the user in exchange for the user's stored value. In another embodiment, the user may choose to have the alternative form of value provided electronically, by sending an electronic form of value to an account held by the user, such as the user's bank account, credit card account, a debit card account, a utility account, a merchant account, or a combination of them. The electronic value could, in addition or alternatively, be sent via email, electronic message, or in an electronic format usable by an application running on a desktop or mobile computer, wireless telephone, personal mobile device such as a smart phone or iPad, or any other general or specialized electronic device. This electronic form of value may, alternatively or in addition, be sent to an account, email address or electronic device not associated directly with the user, such as a friend, relative, charity, merchant, utility company, financial institution, etc.

The user may, in one embodiment, be required to provide his or her stored value to the entity whose offer was accepted or an agent thereof. For example, the user may be required to deposit the user's stored-value card into a card slot 112, capable of detecting receipt of the stored-value card and providing the actual card to a storage location securely inside apparatus 100. Card slot 112 could also provide the functionality of card reader 102, so that card reader 102 could be eliminated. In this embodiment, a notification may be transmitted to the entity whose offer was accepted, alerting the entity that the user has, in fact, surrendered the stored-value card to apparatus 100. In another embodiment, the user retains possession of the card after the exchange has taken place and the user physically provides the card to the entity whose offer was accepted by the user via mail or by directly visiting the entity and providing the card in person. In yet another embodiment, the user retains possession of the stored-value card, but the value associated with the stored-value card is transferred to the entity whose offer was accepted via electronic means. In this embodiment, a notification is sent to the particular entity and/or a third party so that the value is electronically transferred to the entity or to some other party selected by the entity. The stored-value card retained by the user may have its stored-value account information altered to reflect the reduction in value associated with the exchange. This would prevent the user from trying to redeem the stored value or otherwise transferring the value formally associated with the account.

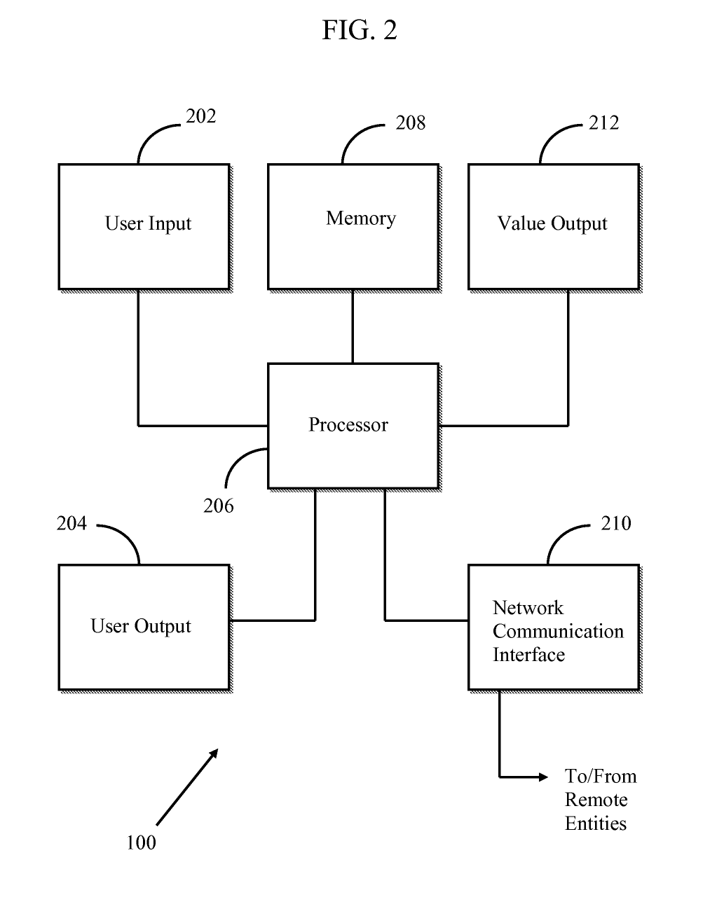

FIG. 2 is a functional block diagram illustrating the functional components of apparatus 100. It should be understood that in some embodiments, not all of the functional blocks will be required to enable stored value exchanges.

User input device 202 generally describes hardware and/or software necessary for the user to provide stored-value account information to apparatus 100. Typically, user input device 202 comprises a keyboard, keypad, touch-screen device, card reader, audio capture device, such as a microphone, and/or any other device for receiving electronic, RF, audio, or optical information that is well-known in the art. In one embodiment, a stored value exchange begins when the user enters stored-value account information relating to the user's stored value into apparatus 100 using user input device 202. For example, the user may be prompted to begin a transaction by touching a touch-screen device, depressing a key on a keyboard or keypad, speaking a command, or simply by swiping or otherwise providing the stored-value account information (or a stored-value card itself) to the user input device 202. In another embodiment, the stored-value account information is provided to apparatus 100 by a remote entity via network communication interface 210 during a prior transaction.

The stored-value account information provided to apparatus 100 typically, at a minimum, comprises an numeric or alpha-numeric code assigned to the stored value that uniquely identifies the stored value. In other embodiments, the stored-value account information comprises an account number, one or more merchants associated with the account number, an account balance, an amount of the account value or balance willing to be exchanged for another form of value, and/or an owner of the stored value. In one embodiment, the stored-value account information is stored on an object or device possessed by a user of apparatus 100. In another embodiment, only a minimum amount of information is stored on an object or device in possession of the user, and other information relating to the stored value is stored at a remote location, such as a server, website, financial institution, merchant, etc.

After the user has provided the stored-value account information to apparatus 100 via user input device 202, it is typically provided to processor 206, where it passed to network communication interface 210. Processor 206 comprises a general-purpose microprocessor well known in the art or it may comprise a custom or semi-custom ASIC able to carry out the functionality required for a stored value exchange. Processor 206 generally performs processor-readable instructions stored in memory 208 that control most or all of the functionality of apparatus 100.

The stored-value account information is received by network communication interface 210. Network communication interface 210 comprises hardware and/or software configured to send the stored-value account information via a communication network, such as a wide-area network, such as the Internet, to one or more remote entities, such as web servers, websites, personal computers, or virtually any other device, fixed or mobile, that is connected to the wide-area network. In other embodiments, network communication interface 210 comprises well-known hardware and/or software for communication with remote entities via a telephone network, a fiber optic network, a satellite network, a radio network, a wireless telephone network, and/or a wireless data network, and/or any other well-known, two-way communication networks.

Network communication interface 210 sends the stored-value account information to at least two remote entities. In one embodiment, at least one of the two entities comprises a web server hosting a website that offers stored-value card exchanges, such as www.plasticjungle.com or www.swapagift.com. Other entities comprise auction websites, merchant websites, financial institutions, such as credit and/or debit card providers, pre-paid telephone or internet providers, or any other entity willing to swap some form of value for the user's stored value.

The aforementioned stored-value card exchange websites (www.plasticjungle.com or www.swapagift.com) offer stored-value card exchange services, offering to pay cash or swap a user's stored value card for another stored-value card in their inventory. A user wishing to swap his or her stored-value card for a different stored-value card (or cash) must visit one of these types of websites via personal computer and enter their stored-value account information manually, typically via a keyboard. The stored-value account information is then sent to the chosen website, and then the user is typically offered a variety of alternative stored-value cards from which to choose. The website verifies and validates the stored-value account information, including balance, then allows the user to exchange the user's stored-value card with a stored-value card that the website possesses in inventory. After the user selects an alternative stored-value card held by the website, the user typically sends his/her stored-value card to the website via mail. After the website receives the user's stored-value card, it sends the alternate stored-value card that the user selected via mail to the user.

In one embodiment, when a first entity receives the stored-value account information, either from apparatus 100 or from a third party validation/verification service provider, it decides whether to offer an alternate form of value to the user. If it decides to do so, the first entity generates a first offer that is sent back to apparatus 100. The first offer may be based on a number of factors, such as the availability of alternative forms of value, the value of the stored value held by the user, a merchant associated with the user's stored value, etc. The first offer may comprise a stored-value card having a different merchant associated with it than a merchant currently associated with the user's stored value and at a different monetary value associated with the stored value held by the user. Alternatively, the offer may comprise a debit card, live event tickets, cash, sporting event tickets, movie tickets, a fuel credit, social network credits (i.e., MySpace or FaceBook), or virtually any other type of alternative value.

At or about the same time the first entity receives the stored-value account information from the network communication interface 210 or a third party validation/verification service provider, a second entity may also receive the same stored-value account information from network communication interface 210 or a third party validation/verification service provider. The second entity also decides whether to make an offer to exchange the user's stored value and, if so, generates second offer that is sent to network communication interface 210. The stored-value account information from network communication interface 210 or a third party validation/verification service provider can be sent to many additional entities for each of those entities to each submit an offer to exchange the user's stored value for an alternative form of value.

For the purposes of discussion, network communication interface 210 receives the first offer and the second offer, without receiving any other offers, even though the stored-value account information may have been sent to more than two entities. In one embodiment, processor 206 only allows a limited time period for offers to be received, typically on the order of 1 to 30 seconds or so. The reason for this is that it is generally desirable to conclude transactions quickly, due to user expectations of quick transactions in public places where devices such as apparatus 100 are typically located.

In one embodiment, the two offers are provided to processor 206 from network communication interface 210. Processor 206 determines which of the two offers, if any, to accept. In one embodiment, processor 206 decides what action to take by comparing the two offers to a predetermined set of criteria stored in memory 208. Memory 208 is typically an electronic memory, comprising RAM, ROM, flash memory, or any other type of known memory device. In another embodiment, processor 206 uses a set of user-defined criteria that the user has either provided directly to apparatus 100 via user input device 202 or the predetermined set of criteria may be stored in a remote location, such as on the user's web server, website, mobile device, or other electronic storage means in communication with network communication interface 210. The predetermined set of criteria may comprise a minimum value that the user will accept, a set of acceptable merchants that the user might use in the future, a comparison between and/or among all offers received to choose the highest offer, or a combination of these and/or other criteria.

Once processor 206 has selected the best offer based on the predetermined set of criteria, it notifies the user by sending a notification to user output device 204, typically in the form of a visual, or audible, or both, message. At that point, the user may grant final acceptance of the offer selected by processor 206 by entering an indication of acceptance to apparatus 100 via user input device 202. After processor 206 receives the final acceptance from the user, it will generally transmit a message to the entity associated with the selected offer, alerting the entity that it's offer was accepted by the user. Processor 206 may, in addition, transmit a notification to other entities, indicating that their offer was rejected by the user. The notification of non-acceptance by the user may comprise information relating to the entity that placed the accepted offer and/or the value that was accepted for exchange from the selected entity. If none of the offers was accepted by the user, a notification may be sent by processor 206 to all of the entities, alerting them that their offers were rejected and possibly also including information relating to the value that was offered from all of the entities that provided an offer.

In another embodiment, rather than processor 206 making decisions regarding offers that are received from remote entities, the user is provided with the offers that are received in response to sending the stored-value account information. The offers are presented to the user via user output device 204. The user then selects which offer the user would like to accept, or none at all. The user's selection is then provided to processor 206 via user input device 202. Processor 206 then sends a message to the entity associated with the selected offer, alerting the entity that it's offer was accepted by the user. Processor 206 may, in addition, transmit a notification to other entities, indicating that their offer was rejected by the user. If none of the offers was accepted by the user, a notification may be sent by processor 206 to all of the entities, alerting them that their offers were rejected.

In yet another embodiment, processor 206 may filter the offers that are received in response to sending the stored-value account information to remote entities based on a set of criteria. For example, processor 206 may present all offers received to the user via user output device 204 as long as the value associated with these offers exceeds some predetermined threshold, typically set by the user. The user then accepts one of the offers presented to the user by processor 206 and user output device 204, or no offers are accepted. In any case, the user enters his/her selection into apparatus 100 using user input device 202, where it is sent to processor 206. If an offer was selected, the processor notifies one or more entities of the acceptance, or rejection, as discussed above.

After the user has accepted one of the offers, an alternative form of value from the user's stored-value card may be provided to the user at apparatus 100. For example, if the offer comprised cash, a pre-paid debit card, event tickets, or the like, one or more forms of alternative value may be dispensed from value output device 212. Value output device 212 may comprise any known device for dispensing cash, receipts, vouchers, tickets pre-paid debit cards, etc. In another embodiment, the user may instruct the remote entity whose offer the user accepted to provide the alternative value in the form electronically to the user. Examples of this include sending an email to an email account associated with the user or to any other email account the user designates, or instructing the remote device to provide an the alternative value to the user's smart phone or other portable electronic device via a secure electronic credit.

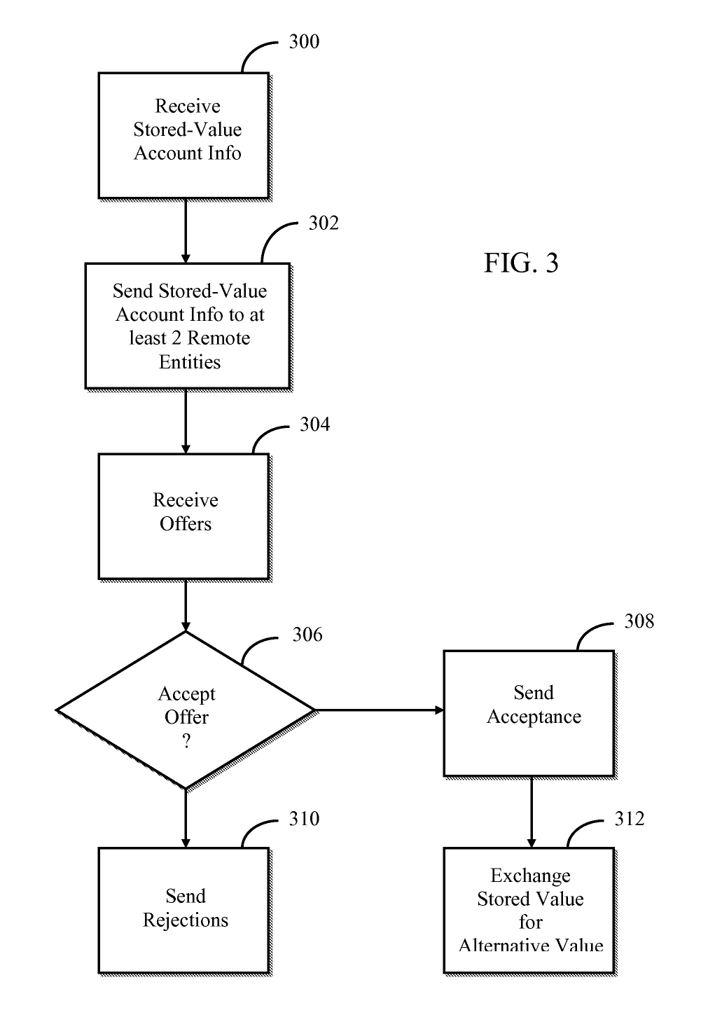

FIG. 3 is a flow diagram illustrating an embodiment for exchanging one form of stored value for an alternative form of value. In step 300, a user wishing to exchange the user's stored value enters stored-value account information associated with the user's stored-value card into a device, such as apparatus 100. The stored-value account information is received by the device via a user input device, such as card reader, manual entry, or other means, by the user. In another embodiment where the device comprises a mobile communication device, the stored-value account information may already reside within the mobile communication device from a prior transaction.

In step 302, the stored-value account information is transmitted to at least two remote entities, such as websites, web servers, personal computers, or personal wireless devices. Each remote entity evaluates the stored-value account information and determines whether to submit an offer to exchange the user's stored-value for another form of value. If so, an entity sends an offer back to the device, where it is received as shown in step 304.

In step 306, it is determined whether to accept any received offer(s). The decision to accept an offer may be accomplished by the user, by a processor within the device, or a combination of both. If no received offers are acceptable, a rejection notification may be sent to each entity who submitted an unacceptable offer, as shown as step 310. If one of the offers is accepted, a notification is sent to the entity that provided the acceptable offer, as shown in step 308. In one embodiment, notifications are also sent to the other entities that provided an unaccepted offer, notifying them of such. The user then exchanges the user's stored value for the alternative value offered by the remote entity that provided the acceptable offer, as shown in step 312.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention can include a computer readable media embodying a code or processor-readable instructions to implement the methods of operation of the kiosk in accordance with the methods, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A method for exchanging stored value for another form of value, comprising:
electronically sending stored-value account information relating to the stored value to a first remote entity and to a second remote entity;
electronically receiving a first offer to exchange at least some of the stored value for another form of value from the first remote entity and receiving a second offer to exchange at least some of the stored value for another form of value from the second remote entity; and
accepting one of the offers.

2. The method of claim 1, further comprising:
receiving the stored-value account information from a user.

3. The method of claim 1, further comprising:
receiving the stored-value account information through a network communication interface.

4. The method of claim 1, wherein accepting either the first offer or the second offer comprises:
evaluating the first offer and the second offer against a set of predetermined criteria; and
selecting one of the offers based on the evaluation.

5. The method of claim 1, wherein accepting one of the offers comprises:
providing the first offer and the second offer to a user; and
allowing the user to select one of the offers.

6. The method of claim 1, wherein sending the stored-value account information to the first remote entity comprises transmitting the stored-value account information to a stored-value exchange website.

7. The method of claim 1, wherein the first and second offers are received within a short time period after sending the stored-value account information to the first and second remote entities.

8. An apparatus for exchanging stored value for another form of value, comprising:
a network communication interface for sending stored-value account information relating to the stored value to a first remote entity and to a second remote entity, and for receiving a first offer to exchange at least some of the stored value for an alternative form of value from the first remote entity and for receiving a second offer to exchange at least some of the stored value for an alternative form of value from the second remote entity;
a user output device for presenting the first and second offers to a user;
a user input device for receiving an indication from the user of an acceptance of one of the offers.

9. The apparatus of claim 8, wherein the network communication interface is further for receiving the stored-value account information prior to sending the stored-value account information to the first and second remote entities.

10. The apparatus of claim 8, wherein the user input device is further for receiving the stored-value account information from the user.

11. The apparatus of claim 8, wherein sending the stored-value account information to the first remote entity comprises providing the stored-value account information to a stored-value exchange website.

12. The apparatus of claim 8, wherein the first and second offers are received within a short time period after sending the stored-value account information to the first and second remote entities.

13. The apparatus of claim 8, wherein the apparatus is selected from the group consisting of a personal computer, a kiosk, or a personal wireless device.

14. An apparatus for exchanging stored value for another form of value, comprising:
means for providing stored-value account information relating to the stored value to a first remote entity and to a second remote entity;
means for receiving a first offer to exchange at least some of the stored value for another form of value from the first remote entity and for receiving a second offer to exchange at least some of the stored value for another form of value from the second remote entity; and
means for accepting one of the offers.

15. The apparatus of claim 14, further comprising means for receiving the stored-value account information prior to providing the stored-value account information to the first and second remote entities.

16. The apparatus of claim 14, wherein sending the stored-value account information to the first remote entity comprises transmitting the stored-value account information to a stored-value exchange website.

17. The apparatus of claim 14, wherein the first and second offers are received within a short time period after sending the stored-value account information to the first and second remote entities.

18. The apparatus of claim 14, wherein the apparatus is selected from the group consisting of a computer, a kiosk, or a wireless device.

19. The apparatus of claim 14, wherein the means for accepting one of the offers comprises:
means for evaluating the first offer and the second offer against a predetermined set of criteria and for selecting one of the offers based on the evaluation.

20. The apparatus of claim 14, wherein the means for accepting one of the two offers comprises:
means for presenting the first and second offers to a user of the apparatus; and
means for receiving an indication from the user of acceptance of one of the offers.
